(19) United States
(12) Patent Application Publication
(10) Pub. No.: US 2012/0170321 A1
(43) Pub. Date: Jul. 5, 2012

(54) FEEDBACK CIRCUIT WITH REMOTE ON/OFF CONTROL FOR POWER SUPPLY

(75) Inventors: TA-YUNG YANG, MILPITAS, CA (US); CHIEN-TSUN HSU, TAIPEI CITY (TW)

(73) Assignee: SYSTEM GENERAL CORP., TAIPEI HSIEN (TW)

(21) Appl. No.: 13/293,248

(22) Filed: Nov. 10, 2011

Related U.S. Application Data
(60) Provisional application No. 61/429,317, filed on Jan. 3, 2011.

(51) Int. Cl. H02M 3/335

(52) U.S. Cl. 363/16

(57) ABSTRACT

A feedback circuit of power supply according to the present invention comprises a switching controller, an optocoupler, an error amplifier and a timer. The switching controller generates a switching signal in accordance with a feedback signal for regulating an output voltage of the power supply. The optocoupler generates the feedback signal. The error amplifier is coupled to the output voltage of the power supply for generating an amplified signal. The amplified signal is connected to an input of the optocoupler. A remote on/off signal is further coupled to the input of the optocoupler. The timer generates a control signal to disable the switching signal in response to the feedback signal. The control signal is generated after a delay time when the feedback signal is lower than a threshold.

### REFERENCE TO RELATED APPLICATIONS

This Application is based on Provisional Application Ser. No. 61/429,317, filed 3 Jan. 2011, currently pending.

### BACKGROUND OF THE INVENTION

1. Field of the Invention

The present invention relates to a power supply, and more specifically, the present invention relates to a feedback circuit with remote on/off control for power supply.

2. Description of Related Art

FIG. 1 shows a prior art of a power supply. The power supply comprises a switching circuit 50 and a transformer 10 with a primary-side and a secondary-side. The primary-side includes a primary winding N_{P} and the secondary-side includes a secondary winding N_{S}. The switching circuit 50 is used to switch the transformer 10 and control power energy for transferring from an input voltage V_{IN} of the power supply and the primary-side of the transformer 10 to the secondary-side of the transformer 10. A rectifier-and-filter circuit 20 is coupled to the secondary-side of the transformer 10 for generating an output voltage V_{O} at an output of the power supply. An error amplifier 25 is coupled to the output of the power supply for generating an amplified signal FB at an output of the error amplifier 25.

An optocoupler 30 is placed between the primary-side and the secondary-side of the transformer 10 for electrical isolation. The optocoupler 30 is also coupled between the error amplifier 25 and the switching circuit 50. The optocoupler 30 is coupled to the error amplifier 25 to receive the amplified signal FB for generating a feedback signal V_{FB}. The feedback signal V_{FB} is correlated to the amplified signal FB and the output voltage V_{O} of the power supply. A resistor 41 is coupled between a voltage V_{B} and the optocoupler 30 at the secondary-side of the transformer 10. The switching circuit 50 switches the transformer 10 in accordance with the feedback signal V_{FB} for regulating the output voltage V_{O} of the power supply.

A supervisor circuit (HW) 40 is coupled to receive a remote on/off signal PSON for generating a signal FLT. An optocoupler 35 is placed between the primary-side and the secondary-side of the transformer 10 for electrical isolation. The optocoupler 35 is also coupled between the supervisor circuit 40 and the switching circuit 50. The optocoupler 35 is coupled to the supervisor circuit 40 to receive the signal FLT for generating an enable signal EN. The enable signal EN is correlated to the signal FLT and the remote on/off signal PSON. The enable signal EN is used to turn on/off the switching circuit 50. A resistor 42 is coupled between the voltage V_{B} and the optocoupler 35 at the secondary-side of the transformer 10. The optocouplers 30 and 35 are required to have the creepage distance in the PCB for the safety consideration. Thus, the optocouplers need more PCB space, which is a limitation for reducing the size of the power supply.

### SUMMARY OF THE INVENTION

The object of present invention is to reduce the need of one optocoupler in order to reduce the size and the cost of the power supply. The present invention provides a feedback circuit including the function of remote on/off control for power supply.

The present invention provides a feedback circuit with remote on/off control for power supply. The feedback circuit according to the present invention comprises a switching controller, an optocoupler, an error amplifier and a timer. The switching controller generates a switching signal in accordance with a feedback signal for regulating an output voltage of the power supply. The optocoupler generates the feedback signal. The error amplifier is coupled to the output voltage of the power supply for generating an amplified signal. The amplified signal and a remote on/off signal are connected to an input of the optocoupler. The timer generates a control signal to disable the switching signal in response to the feedback signal. The control signal is generated after a delay time when the feedback signal is lower than a threshold.

### BRIEF DESCRIPTION OF THE DRAWINGS

The invention can be more fully understood by reading the subsequent detailed description and examples with references made to the accompanying drawings, wherein:

FIG. 1 shows a schematic diagram of the conventional power supply.

FIG. 2 shows a schematic diagram of a preferred embodiment of a power supply in accordance with the present invention.

FIG. 3 shows a schematic diagram of a preferred embodiment of a switching circuit in accordance with the present invention.

FIG. 4 shows a schematic diagram of a preferred embodiment of a switching controller in accordance with the present invention.

### DESCRIPTION OF THE PREFERRED EMBODIMENTS

The following description is of the best-contemplated mode of carrying out the invention. This description is made for the purpose of illustrating the general principles of the invention and should not be taken in a limiting sense. The scope of the invention is best determined by reference to the appended claims.

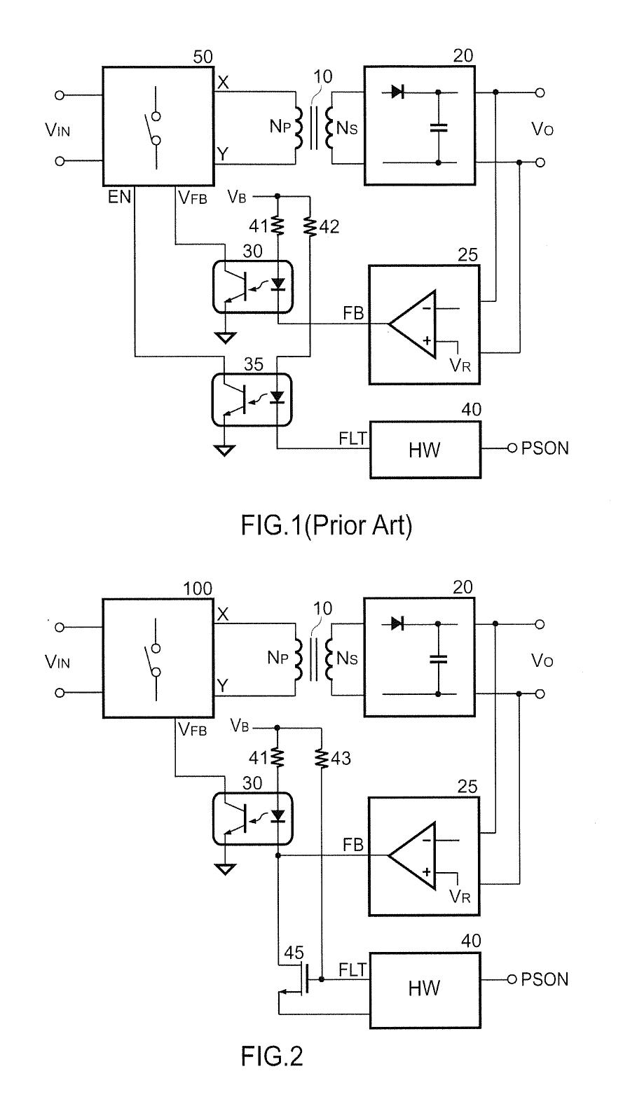

FIG. 2 shows a schematic diagram of a preferred embodiment of a power supply in accordance with the present invention. Comparing with the FIG. 1, this preferred embodiment is similar to the circuits shown in FIG. 1 and the power supply only needs one optocoupler 30 and further comprises a transistor 45 in accordance with the present invention.

A supervisor circuit (HW) 40 receives a remote on/off signal PSON for generating a signal FLT. The signal FLT is correlated to the remote on/off signal PSON. A transistor 45 is placed at the secondary-side of the transformer 10. The transistor 45 is also coupled between the supervisor circuit 40 and the optocoupler 30. A gate of the transistor 45 receives the signal FLT to switch the transistor 45. Therefore, the transistor 45 is controlled by the remote on/off signal PSON. The gate of the transistor 45 is further coupled to the voltage V_{B} through a pull-high resistor 43. The pull-high resistor 43 is coupled between the voltage V_{B} and the gate of the transistor 45. A drain of the transistor 45 is coupled to an input of the optocoupler 30 for driving the optocoupler 30 in response to the remote on/off signal PSON. The input of optocoupler 30 is coupled to the drain of the transistor 45 and an output of the error amplifier 25 to receive the amplified signal FB. A source of the transistor 45 is coupled to the supervisor circuit 40.

An output of the supervisor circuit 40 is coupled to the output of the error amplifier 25 in parallel through the transistor 45. Therefore, the feedback signal V_{FB} is generated in accordance with the amplified signal FB and the signal FLT through the optocoupler 30. A switching circuit 100 is used to switch the transformer 10 and control power energy for transferring from the input voltage V_{IN} of the power supply and the primary-side of the transformer 10 to the secondary-side of the transformer 10. The switching circuit 100 is further coupled to the optocoupler 30 for receiving the feedback signal V_{FB}. The switching circuit 100 switches the transformer 10 in accordance with the feedback signal V_{FB} for regulating the output voltage V_{O} of the power supply.

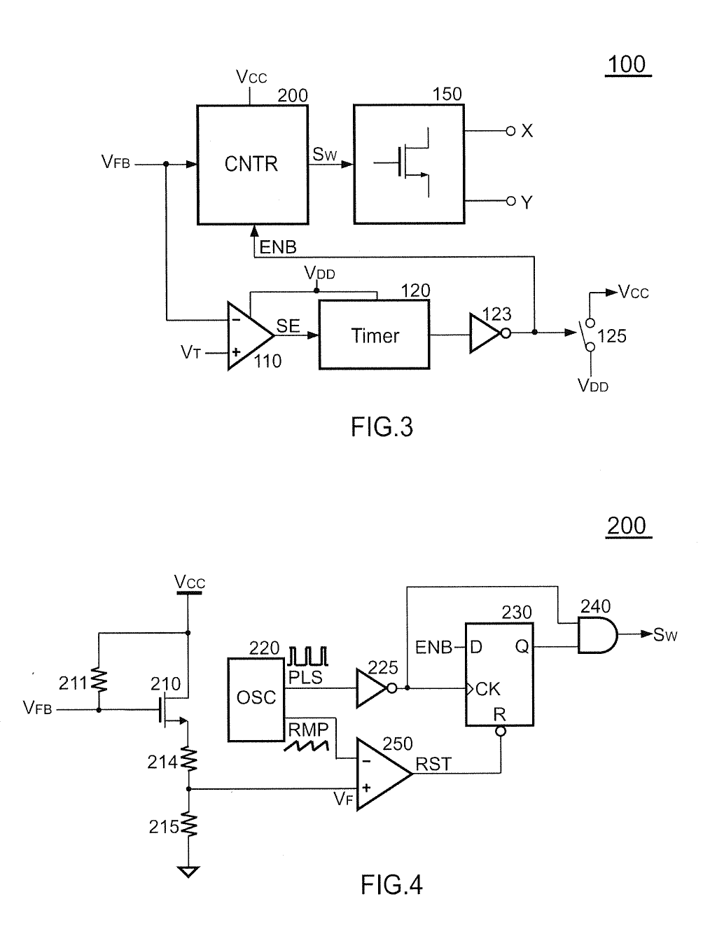

When the signal FLT determined by the remote on/off signal PSON is pulled low, the transistor 45 will be turned off and the optocoupler 30 is only controlled by the error amplifier 25. The error amplifier 25 has an open-drain output. Once the signal FLT determined by the remote on/off signal PSON is logic high (floating with the pull-high resistor 43), the transistor 45 will be turned on and a current will be flowed through the resistor 41, the optocoupler 30 and the transistor 45. The feedback signal V_{FB} is thus pulled low to turn off the switching of the switching circuit 100. If the feedback signal V_{FB} is pulled low over a delay time, then the switching circuit 100 will be turned off for the power saving. A watch-dog timer (Timer) 120 shown in FIG. 3 will monitor the feedback signal V_{FB} periodically. Once the feedback signal V_{FB} is pulled high over a threshold V_{T} (shown in FIG. 3), the switching circuit 100 will be enabled again to regulate the output voltage V_{O}.

FIG. 3 shows a schematic diagram of a preferred embodiment of the switching circuit 100 in accordance with the present invention. The switching circuit 100 comprises a comparator 110, a watch-dog timer (Timer) 120, an inverter 123, a switch 125, a switching controller (CNTR) 200 and a power stage circuit 150. The power stage circuit 150 including a power transistor is coupled to switch the transformer 10 (shown in FIG. 2) in response to a switching signal S_{W}.

The switching controller (CNTR) 200 is coupled to receive the feedback signal V_{FB} to generate the switching signal S_{W} for regulating the output voltage V_{O} of the power supply. The switching controller 200 further receives a source signal V_{CC}. The source signal V_{CC} provides a power source to the switching controller 200. A negative input of the comparator 110 receives the feedback signal V_{FB}. A threshold V_{T} is applied to a positive input of the comparator 110. A supply voltage V_{DD} is supplied with the comparator 110 for providing a power source. The comparator 110 is used to compare the feedback signal V_{FB} with the threshold V_{T} for generating a signal SE at an output of the comparator 110. The supply voltage V_{DD} is supplied with the watch-dog timer 120 for providing a power source as well.

The watch-dog timer 120 receives the signal SE for generating a control signal ENB through the inverter 123. The watch-dog timer 120 thus generates the control signal ENB in response to the feedback signal V_{FB}. An input of the inverter 123 is coupled to the watch-dog timer 120. An output of the inverter 123 is coupled to the switching controller 200 and the switch 125. One terminal of the switch 125 is supplied with the source signal V_{CC}. The other terminal of the switch 125 is applied to the supply voltage V_{DD}. A control terminal of the switch 125 is controlled by the output of the watch-dog timer 120 via the inverter 123.

The watch-dog timer 120 is used to count a period in response to the signal SE when the feedback signal V_{FB} is lower than the threshold V_{T}. Once the feedback signal V_{FB} is lower than the threshold V_{T} over the delay time (such as 300 msec), the switching signal S_{W} will be disabled and then the switching controller 200 will be turned off. The 300 msec is only an embodiment of the present invention. The watch-dog timer 120 is coupled to control the switching controller 200 through the inverter 123 and the switch 125. When the signal FLT (shown in FIG. 2) is pulled high and the transistor 45 (shown in FIG. 2) is turned on in response to the remote on/off signal PSON (shown in FIG. 2), the feedback signal V_{FB} is lower than the threshold V_{T} and the signal SE is enabled. Because the signal SE is enabled, the watch-dog timer 120 starts to count the period. The watch-dog timer 120 will generate the control signal ENB through the inverter 123 after the signal SE is enabled continuously and the period is over the delay time.

The control signal ENB is disabled to turn off the switching controller 200 and the switch 125. Once the switch 125 is turned off by the control signal ENB, the power source of the witching controller 200 is thus turned off. The switch 125 is utilized to control the source signal V_{CC} of the switching controller 200 in response to the control signal ENB for power saving. Once the source signal V_{CC} of the switching controller 200 is disabled, the watch-dog timer 120 will periodically check the level of the feedback signal V_{FB}.

When the signal FLT is pulled low and the transistor 45 is turned off in response to the remote on/off signal PSON, the feedback signal V_{FB} is higher than the threshold V_{T} and the signal SE is disabled. Because the signal SE is disabled, the watch-dog timer 120 stops counting the period and the control signal ENB is enabled. The switching controller 200 will enable the switching signal S_{W} when the control signal ENB is enabled and the control signal ENB also turns on the switch 125 for providing the supply voltage V_{DD} to the switching controller 200 when the control signal ENB is enabled. Therefore, the present invention provides a feedback circuit including the switching controller 200, the error amplifier 25, the optocoupler 30 and the watch-dog timer 120. The feedback circuit includes the function of remote on/off control for the power supply.

FIG. 4 shows a schematic diagram of a preferred embodiment of the switching controller 200 in accordance with the present invention. The switching controller 200 includes a feedback-input circuit, a comparator 250, an oscillator (OSC) 220, an inverter 225, a Flip-Flop 230 and an AND gate 240. The feedback-input circuit comprises a transistor 210, a pull-high resistor 211 and a voltage divider having two resistors 214 and 215 in series. A gate of the transistor 210 is coupled to receive the feedback signal V_{FB}. The pull-high resistor 211 is connected from a drain of the transistor 210 to the gate of the transistor 210. The source signal V_{CC} is supplied with the drain of the transistor 210. The resistor 214 is connected from a source of the transistor 210 to one terminal of the resistor 215. The other terminal of the resistor 215 is connected to the ground. The feedback-input circuit receives the feedback signal V_{FB} to generate a level-shift signal V_{F} at a joint of the resistors 214 and 215. The level-shift signal V_{F} is correlated to the feedback signal V_{FB}.

The oscillator 220 generates a pulse signal PLS and a ramp signal RMP. A clock input CK of the Flip-Flop 230 receives the pulse signal PLS via the inverter 225. The inverter 225 is coupled between the oscillator 220 and the clock input CK of the Flip-Flop 230. The control signal ENB is supplied with an input D of the Flip-Flop 230. A first input of the AND gate 240 is coupled to the oscillator 220 to receive the pulse signal PLS via the inverter 225. The inverter 225 is further coupled between the oscillator 220 and the first input of the AND gate 240. A second input of the AND gate 240 is coupled to an output Q of the Flip-Flop 230.

The level-shift signal V_{F} generated by the feedback-input circuit is supplied with a positive input of the comparator 250. A negative input of the comparator 250 is coupled to the oscillator 220 to receive the ramp signal RMP. A reset signal RST is generated by comparing the level-shift signal V_{F} with the ramp signal RMP. The reset signal RST generated at an output of the comparator 250 is coupled to a reset input R of the Flip-Flop 230 to reset the Flip-Flop 230 for disabling the switching signal S_{W} when the ramp signal RMP is higher than the level-shift signal V_{F}. Therefore, the switching controller 200 is utilized to disable the switching signal S_{W} in response to the feedback signal V_{FB}. The level-shift signal V_{F} is correlated to the feedback signal V_{FB}.

An output of the AND gate 240 generates the switching signal S_{W} in response to the pulse signal PLS, the control signal ENB and reset signal RST. However, The switching signal S_{W} is disabled when the period counted by the watch-dog timer 120 is over the delay time and the control signal ENB is disabled. As mentioned above, the remote on/off signal PSON is coupled to the input of the optocoupler 30 through the supervisor circuit 40 and the transistor 45 for controlling the switching circuit 100 (shown in FIG. 2). In accordance with the present invention, only one optocoupler 30 is needed for both feedback loop regulation and remote on/off control.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A feedback circuit of a power supply, comprising:
a switching controller generating a switching signal in accordance with a feedback signal for regulating an output voltage of the power supply;
an optocoupler generating the feedback signal;
an error amplifier coupled to the output voltage of the power supply for generating an amplified signal connected to an input of the optocoupler, in which a remote on/off signal is further coupled to the input of the optocoupler; and
a timer generating a control signal to disable the switching signal in response to the feedback signal;
wherein the control signal is generated after a delay time when the feedback signal is lower than a threshold.

2. The feedback circuit as claimed in claim 1, wherein the control signal is further coupled to turn off a power source of the switching controller.

3. The feedback circuit as claimed in claim 1, wherein the timer will generate the control signal to enable the switching controller for enabling the switching signal once the feedback signal is higher than the threshold.

4. The feedback circuit as claimed in claim 1, wherein the remote on/off signal is coupled to the optocoupler through a supervisor circuit.

5. The feedback circuit as claimed in claim 4, wherein an output of the supervisor circuit is parallel coupled to an output of the error amplifier, the output of the error amplifier is connected to the input of the optocoupler.

6. The feedback circuit as claimed in claim 4, further comprising a transistor coupled between the supervisor circuit and the optocoupler to drive the optocoupler for controlling the switching controller, wherein the transistor is controlled by the remote on/off signal.

7. The feedback circuit as claimed in claim 6, wherein the transistor is turned off in response to the remote on/off signal and the optocoupler is only controlled by the error amplifier, once the transistor is turned on in response to the remote on/off signal, a current will be flowed through the optocoupler and the transistor and the feedback signal is thus pulled low to disable the switching signal.

8. The feedback circuit as claimed in claim 6, further comprising a pull-high resistor coupled between a voltage and a gate of the transistor.

9. The feedback circuit as claimed in claim 1, wherein the timer starts to count a period when the feedback signal is lower than the threshold, once the feedback signal is lower than the threshold continuously and the period is over the delay time, the timer generates the control signal to turn off the switching controller and disable the switching signal.

10. The feedback circuit as claimed in claim 1, wherein an output of the error amplifier is open-drain.
